(19) United States
(12) Patent Application Publication
(10) Pub. No.: US 2002/0116329 A1
(43) Pub. Date: Aug. 22, 2002

(54) Systems and methods for approval of credit/debit account transactions using a wireless device

(76) Inventors: Bekir Sami Serbetcioglu, Easton, CT (US); Sevket Ilhan Bagoren, Westport, CT (US); Esref Salih Ozulkulu, Monroe, CT (US)

Correspondence Address: David P. Gordon, Esq, 65 Woods End Road, Stamford, CT, 06905, US

(21) Appl. No.: 09/789,077

(22) Filed: Feb. 20, 2001

(51) Int. Cl. G06F 17/60

(52) U.S. Cl. 705/39

(57) ABSTRACT

The systems and methods of the invention utilize a wireless device such as a mobile phone, personal digital assistant (PDA) with wireless massaging capabilities, two-way pager, etc. to notify the account holder of a pending credit/debit account transaction and to obtain approval from the account holder. In order to provide nearly universal interoperability with existing vendors, the invention employs an “authorizing entity”. The authorizing entity may be provided by the credit/debit card issuer or may be provided by a third party in communication with the card issuer. In the broadest sense, the methods of the invention include the steps of sending a message (including the vendor ID and payment amount) from the wireless device to the authorizing entity and sending a payment confirmation message from the authorizing entity to the vendor. Methods of enhancing the customer's privacy are also disclosed.

### BACKGROUND OF THE INVENTION

1. Field of the Invention

The invention relates to systems for executing secure credit/debit account transactions. More particularly, the invention relates to systems and methods for approving credit/debit account transactions with a wireless device.

2. State of the Art

Many, perhaps most retail transactions are completed by payment with a credit card or a debit card. Most credit card transactions lack security. In person to person credit card transactions, the only security feature is the requirement for the purchaser's signature. This is a relatively ineffective security feature because merchants rarely check signatures and signatures are easily forged. In many cases, credit card transactions are completed without any signature. For example, in telephone order and Internet shopping, most often neither a signature nor any other type of security device is employed to determine whether the purchaser is the lawful owner of the credit card. Debit cards are often used interchangeably with credit cards and in such situations they are as vulnerable to fraud as credit cards.

Most debit card accounts, and some credit card accounts, have an associated personal identification number (PIN) which provides an added level of security in some transactions. In the case of credit cards, the PIN is only used when the credit card is used to obtain cash from a cash machine. In the case of debit cards, the PIN is used with cash machines and with many point of sale terminals, such as those in grocery stores.

Although a PIN code can offer an added level of security, when it is employed, PIN codes are vulnerable in many respects. For example, an eavesdropper can watch someone enter a PIN. With the PIN and the card number, a thief can gain access to the entire account balance. Even with the card number alone, PIN codes can be compromised by obtaining other information about the lawful owner of the account. Many people foolishly choose PIN codes which are based on personal data, e.g. phone numbers, birthdays, zip codes, house address, pet names, family surnames, etc. A thief having access to such personal data (and many people publish such data via their Internet “home page”) can often guess the PIN or discover it through a process of elimination.

Although many credit card issuers protect card holders against fraud in excess of $50, such is not the case with debit cards. A thief with a debit card and PIN can empty the owner's account before the owner even discovers that the card has been stolen. Most banks do not protect account holders against such fraud. The only protection is a daily limit on the amount of cash that can be withdrawn from a cash machine and often that limit is relatively high, certainly much higher than $50.

### SUMMARY OF THE INVENTION

It is therefore an object of the invention to provide systems and methods for improving the security of credit/debit account transactions.

It is also an object of the invention to provide systems and methods for improving the security of credit/debit account transactions which cannot be compromised even if the account number and PIN are stolen.

It is another object of the invention to provide systems and methods for improving the security of credit/debit account transactions whereby an account holder is immediately notified of an attempted fraudulent transaction.

It is still another object of the invention to provide systems and methods for improving the privacy of credit/debit account transactions.

In accord with these objects which will be discussed in detail below, the systems and methods of the present invention utilize a wireless device such as a mobile phone, personal digital assistant (PDA) with wireless messaging capabilities, two-way pager, etc. to notify the account holder of a pending credit/debit account transaction and to obtain approval from the account holder. In order to provide nearly universal interoperability with existing vendors, the invention employs an “authorizing entity”. The authorizing entity may be provided by the credit/debit card issuer or may be provided by a third party in communication with the card issuer. In the broadest sense, the methods of the invention include the steps of sending a message (including the vendor ID and payment amount) from the wireless device to the authorizing entity and sending a payment confirmation message to the vendor. According to the invention, messages may be formed and transmitted in different ways and may be encrypted. The content of messages may, and preferably does, include more information than the vendor ID and payment amount. Such additional information may include an account identifier, a PIN code, and a transaction ID.

One embodiment of the methods of the invention includes the following steps: A vendor presents a customer with a conventional bill. The customer presents the vendor with a credit/debit card or an account number. The vendor prepares an electronic bill and transmits it to the customer's wireless device. The customer reviews the bill via the wireless device and may modify the bill, e.g. by adding a tip, before transmitting the bill to the authorizing entity for payment. The bill is then transmitted to the authorizing entity for payment. The authorizing entity verifies that the account has sufficient funds/credit to pay the bill. If sufficient funds/credit are available, the authorizing entity sends an authorization (e.g., an approval code) to the vendor. This method requires that the vendor have the ability to send a wireless message to the customer's wireless device, but it does not require any special connection between the vendor and the authorizing entity. The authorizing entity may approve the transaction via a normal telephone. Nevertheless, according to a presently preferred system for performing this method of the invention, the vendor is provided with a wireless point of sale device for communicating with both the customer's wireless device and the authorizing entity. Preferably, all messages exchanged according to this method are secure messages, e.g. encrypted in some manner such a Public Key Encryption. According to one aspect of the invention, in order to enhance the privacy of the customer, a transcation may be recorded as a cash transaction without maintaining any record of the vendor's name or the nature of the goods/services purchased.

Another embodiment of the methods of the invention includes the following steps: A vendor presents a customer with a conventional bill. The customer presents the vendor with a credit/debit card or an account number. The vendor prepares an electronic bill with the account number and transmits it to the authorizing entity. The authorizing entity verifies that the account has sufficient funds/credit to pay the bill. If sufficient funds/credit are available, the authorizing entity transmits the bill to the customer's wireless device for approval. The customer reviews the bill via the wireless device and may modify the bill, e.g. by adding a tip, before transmitting the bill to the authorizing entity for payment. The authorized bill is then transmitted to the authorizing entity for payment. The authorizing entity pays the bill and notifies the vendor. This method does not require that the vendor possess any special equipment other than a telephone. However, it is preferred that the vendor use a point of sale terminal which sends and receives encrypted messages to/from the authorizing entity.

Other embodiments of the methods of the invention include permutations and combinations of the steps recited above. As mentioned above, common to all the methods are the steps of sending an approval message (including the vendor ID and payment amount) from the wireless device and sending a payment confirmation message to the vendor.

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic diagram illustrating a first method according to the invention;

FIG. 2 is a schematic diagram illustrating a second method according to the invention;

FIG. 3 is a schematic diagram illustrating a third method according to the invention;

FIG. 4 is a schematic diagram illustrating a fourth method according to the invention;

FIG. 5 is a schematic diagram illustrating a fifth method according to the invention; and

FIG. 6 is a schematic diagram illustrating a sixth method according to the invention.

### DETAILED DESCRIPTION OF THE PREFERRED EMBODIMENTS

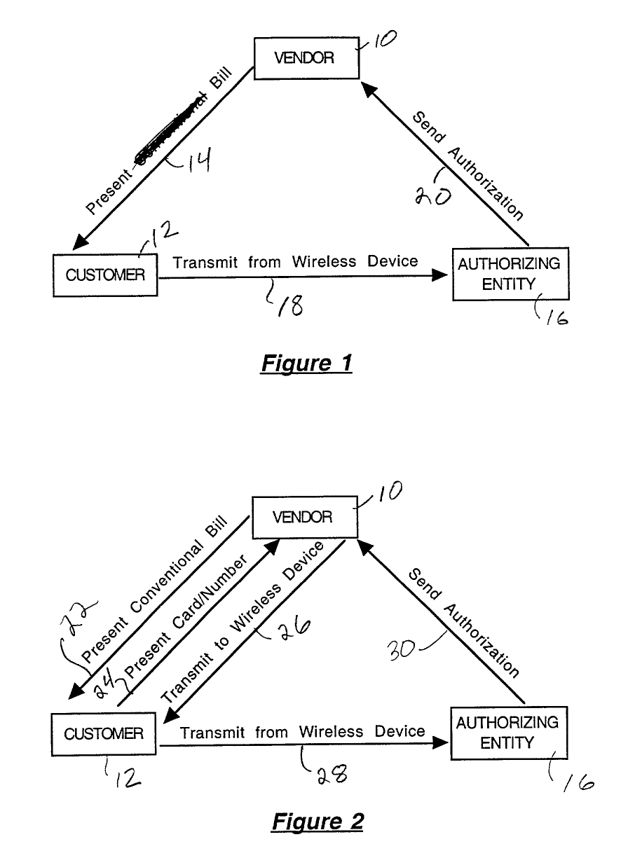

Referring now to FIG. 1, according to a first (simplified) embodiment of the invention, a vendor 10 presents a bill which includes a vendor ID to a customer 12 as indicated by the arrow 14. The customer 12, using a wireless device such as a cell phone, PDA, or pager (not shown) transmits a payment message (e.g. using short message service SMS) to an authorizing entity 16 as shown by the arrow 18. The message sent from the wireless device to the authorizing entity includes the vendor ID and a payment amount. The message may also include an account number, a PIN, and a transaction number. It is possible that the account number can be omitted because the authorizing entity can associate the account with the wireless device ID via a database. However, it is preferred that a PIN be required. The authorizing entity 16 processes the message and sends a payment approval (e.g. via wireless or wireline communication) to the vendor 10 as indicated by the arrow 20. Though not shown in FIG. 1, additional confirmation messages may be sent from the vendor to the authorizing agent and from the vendor or the authorizing agent to the customer. All of the messages, with the possible exception of the confirmation messages are preferably encrypted. According to a preferred embodiment of the invention, a record of the transaction is saved in the wireless device for later review and/or printing.

Turning now to FIG. 2, a more typical example of a retail transaction is illustrated. According to this embodiment, the vendor 10 presents a conventional bill to the customer 12 as indicated by the arrow 22. The bill may be a printed bill such as given in a restaurant, or may be delivered orally or displayed on a cash register as is common in a retail store. The customer 12 then presents a credit/debit card or number to the vendor 10 as indicated by the arrow 24. This step may be performed in the same manner as a conventional credit/debit account transaction is presently effected, e.g. physically handing over a plastic card or swiping a card with a magnetic stripe through a card reader. Alternatively, the customer may speak, type, or handwrite an account number. The vendor 10 takes the account number and composes a bill which includes the account number, the vendor ID, and a payment amount. This composed bill is transmitted by the vendor to the customer's wireless device as indicated by the arrow 26. According to the preferred embodiment, the composition of the bill and the transmitting of it is performed by a point of sale device which is also capable of receiving an authorization message. According to this embodiment, the customer views the composed bill via the wireless device and may modify the payment amount, e.g. by adding a tip. The customer approves payment by sending a message to the authorizing entity 16 as indicated by the arrow 28. The message must include a vendor ID and a payment amount. Preferably the message also includes a PIN and a transaction ID. The authorizing entity 16 reviews the payment approval message, checks to determine whether the account has sufficient funds/credit to pay the bill and sends a payment authorization message to the vendor as shown at arrow 30. The embodiment illustrated in FIG. 2 is closely related to the manner in which conventional credit/debit account transactions are effected. The main difference between the methods of FIG. 2 and existing methods is that the bill is presented for authorization by the customer using the wireless device rather than by the vendor using a modem, card reader and keypad. Thus, according to this method, it is impossible for a thief to complete a transaction using the customer's card unless the thief also has the customer's wireless device and the customer's PIN. The authorization sent at 30 is the same type of authorization as is presently received by a vendor when presenting a bill to a card issuing authority using a modem, etc.

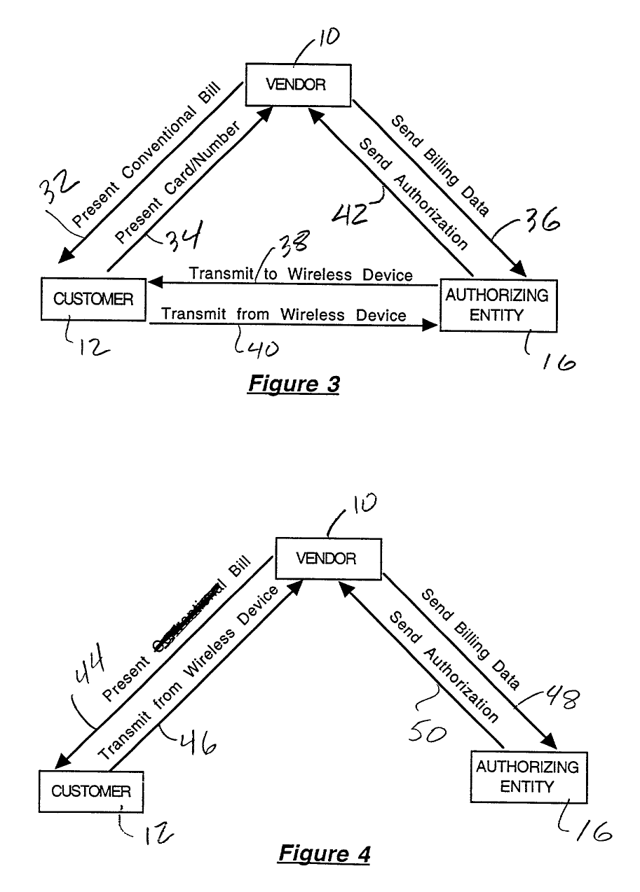

FIG. 3 illustrates a third embodiment of the invention which offers the additional feature of notifying the customer when a thief attempts to used the customer's stolen credit/debit card. Turning now to FIG. 3, the first three steps in this method are substantially the same as a conventional credit/debit card transaction. The vendor 10 presents a bill to the customer 12 as indicated by arrow 32. The customer 12 presents a credit/debit card to the vendor 10 as indicated by arrow 34. The vendor 10 presents the account number and other billing information including payment amount to an authorizing entity 16 as indicated by arrow 36. This last step may be accomplished in the same manner as existing card approval methods, e.g. swiping the card through a reader, keying in bill information and initiating a modem connection to the card issuer. According to the invention, the following steps depart from the normal transaction in use today. Upon receiving an authorization request from the vendor 10, the authorizing entity 16 sends a message to the customer's wireless device as indicated at arrow 38. This message gives the customer 12 the opportunity to approve or disapprove the transaction and to increase the payment amount, e.g. by adding a tip. The authorizing entity 16 will send an authorization message shown at arrow 42 only if the transaction is approved by a message shown at arrow 40 from the customer. It will be appreciated that this method can be implemented with existing credit/debit cards and vendors need not install any special equipment. Additional equipment need only be provided at the authorizing entity for communicating with the customer's wireless device. It will further be appreciated that according to this method, the customer will be immediately notified (e.g. via SMS) if anyone attempts to use the customer's card. It will further be appreciated that the message sent by the customer at arrow 40 may include an indication that the card has been stolen. In such a case, the message sent by the authorizing entity at arrow 42 would not be an authorization and could be a message to the vendor that the card is stolen. In such a case, the vendor could confiscate the card and notify security guards to detain the person attempting to use the stolen card.

FIG. 4 illustrates a fourth embodiment of the invention which requires that the vendor possess equipment for receiving a message from the customer's wireless device. According to this method, the vendor 10 presents a bill which includes a vendor ID to the customer 12 as shown by the arrow 44. The customer composes an encrypted message which includes vendor ID, price, PIN, account number, and sends the encrypted message to the vendor 10 as indicated by the arrow 46. The vendor forwards this encrypted message to the authorizing entity 16 as shown by arrow 48 and the authorizing entity returns an authorization to the vendor as indicated by arrow 50. The encrypted message is preferably encrypted with a key such that it can only be decrypted by the authorizing entity. The advantage of this embodiment is that it can be used with a customer wireless device having limited range, e.g. a PDA with an infrared interface, a BLUE TOOTH interface, an IEEE 802.11b interface, etc.

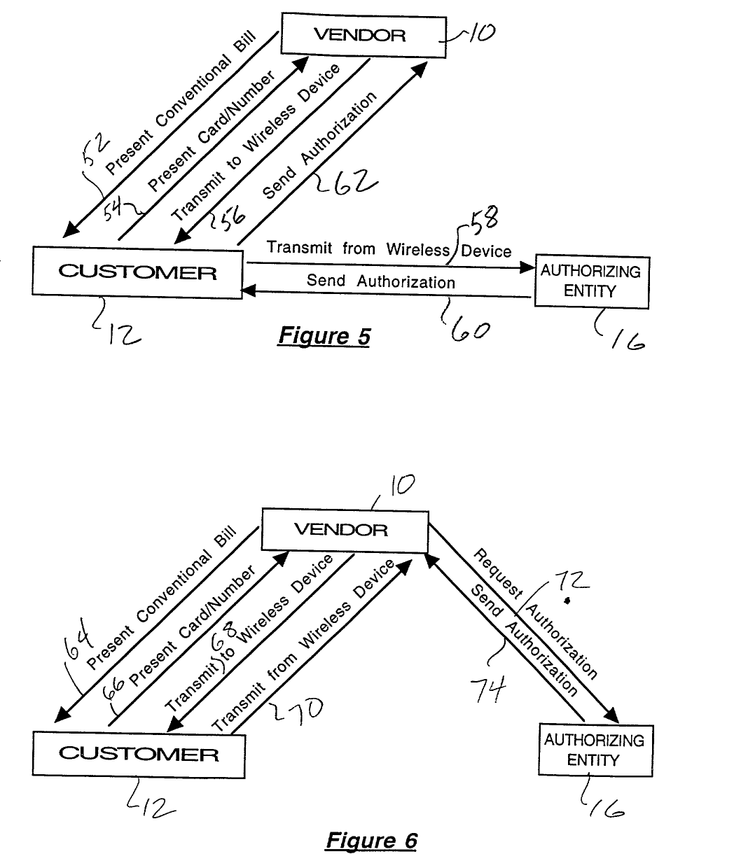

FIG. 5 illustrates an embodiment similar to that shown in FIG. 2 but does not require the vendor to have the ability to receive a message from the authorizing entity. According to this embodiment, the vendor 10 presents a bill to the customer 12 as indicated by the arrow 52. The customer presents a card or account number to the vendor as indicated by arrow 54. The vendor composes a bill with vendor ID, customer account number, payment amount, etc. and transmits it to the customer's wireless device as indicated by the arrow 56. The customer's wireless device then transmits an authorization request to the authorizing entity 16 as indicated by arrow 58. The authorizing entity transmits an approval code back to the customer's wireless device as indicated by arrow 60. Finally, the transaction is completed by the customer's wireless device transmitting the approval code to the vendor as indicated at arrow 62.

FIG. 6 illustrates an embodiment which is a combination of the embodiments of FIGS. 2 and 4. Referring now to FIG. 6, the vendor 10 presents a bill to the customer 12 as indicated at arrow 64. The customer presents a card or number to the vendor at 66. The vendor composes a bill with the customer's account number, vendor ID, and amount payable and transmits it to the customer's wireless device as indicated at 68. The customer reviews the bill, adds a tip if appropriate, enters a PIN and forms an encrypted message containing the information. The encrypted message is transmitted to the vendor at 70. The vendor forwards the encrypted message to the authorizing entity at 72 and the authorizing entity returns an authorization code at 74. The embodiment of FIG. 6 can be used with a customer wireless device having limited range, e.g. a PDA with an infrared interface, a BLUE TOOTH interface, an IEEE 802.11b interface, etc.

There have been described and illustrated herein several embodiments of systems and methods for approval of credit/debit account transactions using a wireless device. While particular embodiments of the invention have been described, it is not intended that the invention be limited thereto, as it is intended that the invention be as broad in scope as the art will allow and that the specification be read likewise. Thus, while a generic “authorizing entity” has been disclosed, it will be appreciated that the authorizing entity may be the card issuer, a bank, or a third party in communication with the card issuer or bank. Also, while messages have been shown to contain certain information, it will be recognized that other types of information may be included in messages for further verification of transactions. Moreover, while it has been stated that messages may be encrypted, it will be appreciated that it may be desirable to encrypt only portions of messages which contain private information. Furthermore, it will be appreciated that messages may be exchanged in a number of ways. Messages between the vendor and the authorizing agent may be sent via wireless or wireline communications. Messages between the vendor and the customer may be sent via a wireless WAN protocol such as SMS, CDPD, GPRS/WAP, Mobitex, etc. or may be sent via a wireless LAN protocol such as BLUE TOOTH, IEEE 802.11b, infrared, etc. Messages between the customer device and the authorizing entity are preferable sent via a wireless WAN protocol. Inasmuch as the customer wireless device has the added value of being able to complete financial transactions, it may be advisable to include a “panic button” which summons the police and/or which permanently disables the device. In addition, the credit/debit account number described above may be a conventional credit/debit card number or it may be a telephone number, an IP address, or any other type of identifier. As contemplated by the invention, the number used by the purchaser can be a public number which is published without concern because it is useless without the wireless device,

It will therefore be appreciated by those skilled in the art that yet other modifications could be made to the provided invention without deviating from its spirit and scope as so claimed.

1. A method for authorizing a financial transaction between a vendor and a customer using a customer wireless device, said method comprising:
a) transmitting a payment message from the customer wireless device, the message including a vendor ID and a payment amount; and
b) transmitting a payment authorization to the vendor, wherein the vendor ID need not be pre-authorized by the customer.

2. The method according to claim 1, wherein:
said step of transmitting a payment message includes transmitting a payment message from the customer wireless device to an authorizing entity, and
said step of transmitting a payment authorization includes transmitting a payment authorization to the vendor from the authorizing entity.

3. The method according to claim 1, further comprising:
prior to said step of transmitting a payment message,
c) transmitting a bill including a payment amount to the customer wireless device.

4. The method according to claim 3, further comprising:
after said step of transmitting a bill and prior to said step of transmitting a payment message,
d) increasing the payment amount using the customer wireless device.

5. The method according to claim 3, further comprising:
prior to said step of transmitting a bill,
d) presenting the vendor with a credit/debit account number.

6. The method according to claim 1, further comprising:
prior to said step of transmitting a payment message,
c) transmitting a bill including a payment amount to an authorizing entity; and
d) transmitting a request for approval from the authorizing entity to the customer wireless device.

7. The method according to claim 6, wherein:
said step of transmitting a payment message includes transmitting a payment message from the customer wireless device to the authorizing entity, and
said step of transmitting a payment authorization includes transmitting a payment authorization to the vendor from the authorizing entity.

8. The method according to claim 1, further comprising:
after said step of transmitting a payment message and prior to said step of transmitting a payment authorization,
c) transmitting an authorization request from the vendor to an authorizing entity, wherein
said step of transmitting a payment message includes transmitting a payment message from the customer wireless device to the vendor, and
said step of transmitting a payment authorization includes transmitting a payment authorization to the vendor from the authorizing entity.

9. The method according to claim 1, wherein:
said step of transmitting a payment message includes transmitting a payment message from the customer wireless device to an authorizing entity, and
said step of transmitting a payment authorization includes transmitting a payment authorization from the authorizing entity to the customer wireless device and then transmitting it from the customer wireless device to the vendor.

10. The method according to claim 2, wherein:
said step of transmitting a payment message includes transmitting a payment message by SMS.

11. The method according to claim 3, wherein:
said step of transmitting a bill includes transmitting a bill by SMS.

12. The method according to claim 1, further comprising:
c) upon completion of the transaction, deleting information about the vendor ID and nature of the goods/services; and
d) recording the transaction as a cash transaction at a particular date and time.

13. A system for authorizing a financial transaction between a vendor and a customer, said system comprising:
a) a customer wireless device having means for transmitting a payment message including a vendor ID and a payment amount; and
b) an autforizing entity having means for transmitting a payment authorization to the vendor, wherein
the vendor ID need not be pre-authorized by the customer.

14. The system according to claim 13, wherein:
said means for transmitting a payment message includes means for transmitting a payment message from the customer wireless device to the authorizing entity, and
said means for transmitting a payment authorization includes means for transmitting a payment authorization to the vendor from the authorizing entity.

15. The system according to claim 13, further comprising:
c) billing means for transmitting a bill including a payment amount to the customer wireless device.

16. The system according to claim 15, wherein:
said custumer wireless device includes means for increasing the payment amount.

17. The system according to claim 13, further comprising:
c) billing means for transmitting a bill including a payment amount to said authorizing entity, wherein
said authorizing entity includes means for transmitting a request for approval to said customer wireless device.

18. The system according to claim 17, wherein:
said means for transmitting a payment message includes means for transmitting a payment message from said customer wireless device to said authorizing entity, and
said means for transmitting a payment authorization includes means for transmitting a payment authorization to the vendor from said authorizing entity.

19. The system according to claim 13, further comprising:
c) point of sale means for transmitting an authorization request from the vendor to an authorizing entity, wherein
said means for transmitting a payment message includes means for transmitting a payment message from said customer wireless device to the vendor, and
said means for transmitting a payment authorization includes means for transmitting a payment authorization to the vendor from said authorizing entity.

20. The system according to claim 13, wherein:
said means for transmitting a payment message includes meaqns for transmitting a payment message from said customer wireless device to said authorizing entity, and
said means for transmitting a payment authorization includes means for transmitting a payment authorization from said authorizing entity to said customer wireless device and means for transmitting it from said customer wireless device to the vendor.

21. The system according to claim 14, wherein:
said means for transmitting a payment message includes means for transmitting a payment message by SMS.

22. The system according to claim 15, wherein:
said means for transmitting a bill includes means for transmitting a bill by SMS.

23. The method according to claim 15, wherein:
said means for transmitting a bill includes means for transmitting a bill by infrared, BLUE TOOTH, or IEEE 802.11b.
